(19) United States
(12) Patent Application Publication
(10) Pub. No.: US 2012/0196240 A1
(43) Pub. Date: Aug. 2, 2012

(54) METHOD AND SYSTEM FOR TREATING SEWAGE SLUDGE

(75) Inventors: Genady Borodyanski, Nesher (IL); Felix Kirzhner, Kiyat-Yam (IL); Yoram Zimmels, Haifa (IL); Tomer Zimmels, Haifa (IL)

(73) Assignee: Technion Research & Development Foundation Ltd., Haifa (IL)

(21) Appl. No.: 13/393,285

(22) PCT Filed: Aug. 30, 2010
(86) PCT No.: PCT/IL2010/000710

§ 371 Date: Feb. 29, 2012

Related U.S. Application Data
(60) Provisional application No. 61/238,170, filed on Aug. 30, 2009.

(51) Int. Cl. F27D 3/00; F02C 3/20; F02G 3/00

(52) U.S. Cl. 432/9; 432/198; 60/39.12

(57) ABSTRACT

A method and system for treating sewage sludge are described herein. A carbonaceous fuel is mixed with sewage sludge, the mixture is then gasified, and the obtained gas is combusted. The method and system may utilize wet sewage sludge.

### FIELD AND BACKGROUND OF THE INVENTION

The present invention, in some embodiments thereof, relates to sewage treatment and more particularly, but not exclusively, to a method and system for treating sewage sludge.

Sewage treatment typically involves formation of sewage sludge by separating solids from the bulk of the wastewater. Sewage sludge typically contains approximately 90-95% water, the balance being mostly solid organic matter. The sludge can be disposed of in a landfill, but this requires considerable landfill space due to the large amounts of sewage sludge produced by modern societies. In addition, the presence of heavy metals, disease-causing microorganisms and/or parasites in sludge creates a health hazard.

In many cases, sludge is treated by being subjected to digestion by microorganisms, in order to reduce the amount of organic matter and the number of disease-causing microorgansims in the sludge. Digestion may be anaerobic or aerobic. Digestion is a slow and costly process, taking up to 30 days for anaerobic digestion. In addition, aerobic digestion typically requires aeration, which increases operating costs.

Incineration of sludge is problematic due to the high energy costs involved and the pollutants in the emissions, and is therefore not commonly used for sludge treatment and disposal. Incineration of sludge is not a cost effective method of producing energy, because of the large amount of energy needed to dry the sludge before the organic matter can be incinerated.

Gasification is an endothermic process that converts carbonaceous materials into carbon monoxide and hydrogen by reacting the carbonaceous material with oxygen and/or steam. The primary chemical reaction in gasification is:

C+H₂O→H₂+CO(+131.4 kJ/mol).

U.S. Pat. No. 4,793,855 describes gasification of dried sewage sludge with a residual moisture of 10% admixed with a solid fuel. An oxygen-containing gas is also fed into the gasifier. Gasification takes place in a fluidized bed formed above the slag bath formed during gasification. The gas produced in the gasifier can be used for power generation or as a reducing gas for iron ore.

U.S. Pat. No. 5,230,211 describes gasification of a slurry comprising solid carbonaceous fuel, ground dried sewage sludge, and dewatered sewage sludge having a solids content of about 17 to 40%, in a weight ratio of 3 to 8:0.5 to 2:0.5 to 2, respectively.

Methods which utilize dried or partially dried sewage sludge have the drawback of requiring prior removal of some or all of the water from the sludge. Such a procedure (e.g., evaporation of the water by heating) typically involves high energy consumption, as well as additional time and equipment.

McAuley et al. [Water Engineering & Management, May 2001, pp. 18-22] describes a system based on gasification of sewage sludge that enables drying of the sludge and reduction of the sludge to its ash content. The process does not require materials other than oxygen and the sludge itself. A combustible gas is produced which can serve as a fuel in a gas turbine, thus providing energy for extracting oxygen from air.

International Patent Application PCT/IL2007/000655 (published as WO 2007/138592) describes generation of power from sewage sludge by introducing a composite fuel into a furnace for combustion, the composite fuel comprising a coal suspension in a liquid sewage sludge medium.

Additional background art includes U.S. Pat. Nos. 4,444,126, 4,526,588 and 7,763,088.

### SUMMARY OF THE INVENTION

The present inventors have now devised and successfully practiced a novel method and system for treating sewage sludge, while utilizing a gasification process.

The devised methods and systems can be utilized for treating sewage sludge while avoiding pre-drying of the sludge.

According to an aspect of some embodiments of the present invention there is provided a method of treating sewage sludge, the method comprising:

(a) mixing a carbonaceous fuel with the sewage sludge so as to form a suspension;

(b) gasifying the suspension so as to produce a gas comprising CO and H₂; and

(c) combusting the gas,

thereby treating the sewage sludge.

According to an aspect of some embodiments of the present invention there is provided a system for treating sewage sludge, the system comprising:

(a) a mixer configured for receiving sewage sludge, for receiving a carbonaceous fuel, and for mixing the fuel with the sewage sludge so as to form a suspension;

(b) a gasifier configured for receiving the suspension from the mixer, and adapted for producing a gas comprising CO and H₂ from the suspension;

(c) a heat source configured for heating the gasifier; and

(d) a combustion module configured for receiving oxygen and for combusting the gas produced in the gasifier.

According to some embodiments of the invention, the method further comprises generating power from the combusting of the gas.

According to some embodiments of the invention, the power is generated by a gas turbine, steam turbine and/or a heat engine.

According to some embodiments of the invention, the suspension comprises particles of the fuel dispersed in the sewage sludge, the particles being characterized by a diameter of 100 μm or less

According to some embodiments of the invention, the particles are characterized by a diameter of 20 μm or less.

According to some embodiments of the invention, the method further comprises, prior to mixing, grinding a solid carbonaceous fuel so as to produce the particles of fuel.

According to some embodiments of the invention, the solid carbonaceous fuel is selected from the group consisting of coal, oil shale and peat.

According to some embodiments of the invention, the method further comprises, prior to mixing, emulsifying a liquid carbonaceous fuel with the sewage sludge so as to produce the particles of fuel.

According to some embodiments of the invention, a weight ratio of the fuel to the sewage sludge in the suspension is in a range of from 0.75:1 to 3:1.

According to some embodiments of the invention, a concentration of water in the suspension is at least 25 weight percents.

According to some embodiments of the invention, the gasifying comprises heating the suspension to a temperature of at least 1000° C.

According to some embodiments of the invention, the heating described herein comprises contacting the suspension with hot combustion products which comprise steam.

According to some embodiments of the invention, the method further comprises mixing the gas with air prior to the combusting of the gas.

According to some embodiments of the invention, the method further comprises mixing a plasticizer with the fuel and the sewage sludge.

According to some embodiments of the invention, the plasticizer is selected from the group consisting of humic acid and sodium hydroxide.

According to some embodiments of the invention, a concentration of the plasticizer in the suspension is in a range of from 0.1% to 3%.

According to some embodiments of the invention, the system further comprises a sewage sludge supply module.

According to some embodiments of the invention, the system further comprises a fuel supply module.

According to some embodiments of the invention, the system further comprises a power generation module configured for generating power from the combusting of the gas in the combustion module.

According to some embodiments of the invention, the power generation module comprises a gas turbine and/or a heat engine.

According to some embodiments of the invention, the system further comprises a grinder capable of grinding a solid carbonaceous fuel so as to produce particles of the fuel having a diameter of 100 μm or less.

According to some embodiments of the invention, the system is adapted for emulsifying a liquid carbonaceous fuel with the sewage sludge so as to produce particles of fuel having a diameter of 100 μm or less.

According to some embodiments of the invention, the particles of the fuel have a diameter of 20 μm or less.

According to some embodiments of the invention, the heat source comprises a furnace.

According to some embodiments of the invention, the system comprises a fuel supply module configured for providing the carbonaceous fuel to the furnace and to the mixer, the furnace being adapted for burning the fuel.

According to some embodiments of the invention, the furnace is configured for supplying combustion products to the gasifier, the combustion products comprising steam.

According to some embodiments of the invention, the furnace and the gasifier are configured as a unified module comprising a first zone in which combustion occurs and a second zone in which gasification occurs.

According to some embodiments of the invention, the unified module further comprises a third zone in which the combustion of the gas occurs, such that the unified module comprises a furnace, gasifier and combustion module described herein.

According to some embodiments of the invention, the heat source and the gasifier are configured for heating the suspension in the gasifier to a temperature of at least 1000° C.

According to some embodiments of the invention, the system further comprises a compressor configured for supplying oxygen to the combustion module.

According to some embodiments of the invention, the oxygen and the gas described herein are supplied together to the combustion module.

According to some embodiments of the invention, the system further comprises a compressor configured for supplying oxygen to the furnace.

According to some embodiments of the invention, supplying oxygen comprises supplying compressed air.

According to some embodiments of the invention, the system is adapted for mixing the fuel with the sewage sludge at a weight ratio in a range of from 0.75:1 to 3:1.

According to some embodiments of the invention, the system is adapted for forming a suspension comprising at least 25 weight percents of water.

According to some embodiments of the invention, the system further comprises an atomizer for atomizing the suspension upon entry into the gasifier.

According to some embodiments of the invention, the atomizer comprises a rotating part configured for reducing clogging of the atomizer by particles of the fuel in the suspension.

According to some embodiments of the invention, the system is adapted for mixing a plasticizer with the fuel and the sewage sludge.

According to some embodiments of the invention, the system is adapted for mixing the plasticizer at a concentration in a range of from 0.1% to 3% plasticizer in the suspension.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a scheme depicting a system for treating sewage sludge according to some embodiments of the present invention;

FIG. 2 is a scheme showing a suspension according to some embodiments of the invention;

FIG. 3 is a scheme depicting a system for treating sewage sludge with combined cycle power generation, according to exemplary embodiments of the present invention; and

FIG. 4 is a drawing of a furnace for both gasification and combustion of gas produced by gasification, according to some embodiments of the invention.

### DESCRIPTION OF SPECIFIC EMBODIMENTS OF THE INVENTION

The present invention, in some embodiments thereof, relates to sewage treatment and more particularly, but not exclusively, to a method and system for treating sewage sludge.

The present inventors have searched for a method of treating sewage sludge which allows safe and convenient disposal of sewage sludge, and which does not require costly and energy-inefficient pre-treatment steps such as drying of the sewage sludge.

While reducing the present invention to practice, the inventors have uncovered that gasification of a mixture of sewage sludge with a fuel, followed by combustion of the obtained gas, allows for efficient and convenient conversion of sewage sludge to combustion products (e.g., CO₂, H₂O, N₂) which can be released safely into the atmosphere, along with a small quantity of ash. The inventors have further uncovered that a system for treating sewage sludge according to this method can be fed a simple carbonaceous fuel, air, and sewage sludge with a high water content, and can be used to generate power as an additional benefit.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

According to an aspect of some embodiments of the invention, there is provided a method of treating sewage sludge, which is effected by mixing a carbonaceous fuel with the sewage sludge so as to form a suspension, gasifying the suspension so as to produce a gas comprising CO and H₂, and combusting the gas (e.g., to CO₂ and H₂O).

As used herein, the term “sewage” refers to any wastewater comprising organic matter, including, but not limited to, domestic wastewater, surface runoff, and industrial wastewater. Organic matter which may be present in sewage includes, without limitation, fecal matter, urine, hair, vomit, paper, sanitary napkins, diapers, food and drinks, pesticides, herbicides, paints, detergents, oils (e.g., gasoline and other fuels, cooking oil, lubricating oil), industrial chemicals, rubber, humus, microorganisms (e.g., bacteria, protozoa), algae, small animals (e.g., worms, insects, arthropods, small fish), plant material (e.g., leaves, grass cuttings), and various types of plastic. In some embodiments, the organic matter is mostly fecal matter.

As used herein, the phrase “sewage sludge” refers to a composition comprising solids derived from sewage. Optionally, the sewage sludge comprises at least 1% solids, optionally, at least 2% solids, optionally at least 3% solids, and optionally at least 5% solids. Typically, the sewage sludge is the material remaining following a wastewater decontamination process, in which the wastewater is separated into decontaminated water and sewage sludge, wherein the sewage sludge contains the residual solids.

As used herein, the terms “treating”, “treatment” and any other grammatical diversions thereof, with respect to sewage sludge refer to a process whereby sewage sludge is advantageously converted to a different form. In other words, sewage sludge treatment, as used herein, refers to management of the sludge that abolishes the content of organic matter therein.

The carbonaceous fuel (also referred to herein simply as “fuel”) may be a solid fuel and/or a liquid fuel. Suitable solid fuels include, without limitation, coal, oil shale, peat, coke and charcoal. Suitable liquid fuels include, without limitation, petroleum and products thereof, such as mazut, gasoline, kerosene and diesel fuel.

In some embodiments, the fuel is coal (e.g., anthracite, steam coal, bituminous coal, sub-bituminous coal and lignite).

The fuel/sewage sludge mixture can thus comprise, for example, solid fuel suspended in water, oil (liquid fuel) in water, and/or water in oil (liquid fuel), along with solid particles (mostly comprising organic matter) present in the sewage sludge. Herein, the term “suspension” is used to refer to any of the aforementioned types of mixtures (including dispersions, emulsions and colloids), and is not intended to be limiting.

In order to facilitate gasification, the fuel is optionally mixed with the sewage sludge in the form of small particles dispersed in the sewage sludge, thereby increasing a contact area between the fuel and water. Optionally the particles (e.g., solid or liquid fuel particles) are characterized by a diameter of 100 μm or less, optionally 50 μm or less, optionally 20 μm or less, and optionally 10 μm or less.

In some embodiments, more than 50% of the fuel particles are characterized by a diameter no more than a maximal diameter described hereinabove. Optionally, at least 80% of the fuel particles, optionally at least 95% of the particles, and optionally at least 99% of the particles are characterized by such a maximal diameter.

In some embodiments, the method further comprises grinding a solid fuel so as to produce small particles of fuel (e.g., particles as described above). In some embodiments, the grinding is performed prior to mixing the fuel with the sewage sludge and/or concomitant with said mixing.

In some embodiments, the method further comprises mixing a liquid fuel so as to produce small particles (e.g., droplets having a diameter described above) of fuel in water and/or water in fuel, for example, by emulsifying the fuel with the sewage sludge.

The grinding or emulsification may utilize any suitable technique and/or apparatus known in the art.

In some embodiments, when a solid fuel is used, grinding is effected by a colloid mill. Other milling techniques, such as, for example, ball milling, conical milling, disk milling, edge milling, hammer milling, mortar grinding, semi-autogenous grinding (SAG), high-pressure grinding, buhrstone milling, and vertical shaft impactor (VSI) milling are also contemplated, as well as combinations of the aforementioned techniques.

In some embodiments, when a liquid fuel is used, an emulsion is formed. Emulsification may be effected by a mixer adapted for such a purpose. For example, the mixer may optionally comprise a blender. Other emulsification techniques, such as, for example, ultrasonic treatment and high-pressure homogenization are also contemplated, as well as combinations of the aforementioned techniques.

The weight ratio of the fuel to the sewage sludge in the suspension is optionally in a range of from 0.75:1 to 3:1 (fuel:sludge). In some embodiments the amount of fuel equals the amount of sludge or is in excess. In some embodiments, weight ratio of the fuel to the sewage sludge in the suspension is in a range of from 1:1 to 2:1, and in some embodiments, it is about 1.5:1.

The sewage sludge is preferably used without being substantially dried beforehand, such that the sludge has a substantial amount of water (optionally at least 90% by weight). The suspension will therefore comprise a substantial proportion of water, optionally at least 20%, optionally at least 25%, optionally at least 30%, optionally at least 35%, optionally at least 40%, optionally at least 45%, and optionally at least 50%, by weight.

As the suspension will comprise a substantial amount of water, the method described herein can readily utilize fuel having a relatively high moisture content (e.g., at least 1%, optionally at least 5%).

It is to be appreciated that fuel with a substantial water content is not particularly useful for other applications, as the water may impede burning, for example. Hence, the method described herein may utilize low-cost fuels or, fuels that are otherwise considered non-useful. In some embodiments, the fuel comprises up to 15% water. Mixing is preferably performed so as to bring water (e.g., from the sewage sludge) into contact with most of, or substantially all of, the fuel particles, to thereby enhance a gasification reaction between fuel and water (when the suspension is heated).

According to optional embodiments, the method further comprises mixing a plasticizer with the fuel and sewage sludge, for example, in order to promote contact (e.g., wetting) between water and fuel particles and/or to stabilize the suspension (e.g., reduce sedimentation). The plasticizer may optionally be mixed into the suspension concomitantly with the mixing of fuel with sewage sludge, subsequent to mixing of fuel with sewage sludge, or the plasticizer may be mixed with the fuel and/or sewage sludge prior to mixing of the fuel with sewage sludge.

A plasticizer may be any compound which stabilizes the fuel/sewage sludge suspension or emulsion. Suitable plasticizers include, without limitation, humic acid and sodium hydroxide. Optionally, a concentration of the plasticizer in the suspension after mixing is in a range of from 0.1% to 3% (by weight), optionally from 0.5% to 2%, and optionally about 1%.

In some embodiments, the plasticizer is characterized by a hydrophobic-lipophilic balance (HLB) in a range of from 3 to 6. As used herein, the HLB is defined as 20×(Mh/M), wherein Mh is the molecular mass of the hydrophilic portion of the plasticizer molecule, and M is the molecular mass of the whole plasticizer molecule.

During the gasification process, the organic matter in the suspension which is derived from the sewage sludge (e.g., biomass) is substantially converted to a gas. CO and H₂ are produced according to the reaction:

C+H₂O→H₂+CO

and optionally, if oxygen is present, also according to the reaction:

C+½O₂→CO

In addition, heating of the suspension typically produces gases by pyrolysis, in which atoms other than carbon (e.g., H, O, N) are released in the form of various gases, such as H₂, CH₄ and other alkanes, H₂O, N₂ and NOx gases, leaving the carbon in the suspension. The carbon remaining in the suspension can then react readily according to the above gasification reactions. It is to be appreciated that H₂ produced by gasification can be effective in reducing NOx (which are well-known pollutants) to N₂.

In addition, gasification partially or completely dehydrates the suspension via chemical reaction of water with carbon-containing material such as the fuel and the organic matter in the sewage sludge. Such dehydration optionally allows for a more stable combustion than what can typically be achieved by direct burning of wet sewage sludge.

As carbon (12 grams/mol) reacts with an equimolar amount of water (18 grams/mol) to produce CO and H₂, approximately 1.5 grams of water (e.g., steam) will gasify 1 gram of carbon. The desired water content of the suspension can optionally be determined according to the aforementioned weight ratio. It is to be appreciated that 1 gram of carbon may correspond to more than 1 gram of fuel, as heating of the fuel may release atoms other than carbon, for example, by pyrolysis, as described hereinabove.

Gasifying optionally comprises heating the suspension to a suitable temperature. As shown in Table 1 below, a significant amount of CO and H₂ is present in equilibrium with steam and carbon at a temperature of 500° C., and CO and H₂ are thermodynamically favored at a temperature of at least 700° C. Optionally, gasifying comprises heating the suspension to at least 1000° C., optionally at least 1100° C., optionally at least 1200° C., and optionally at least 1300° C. In general, the higher the temperature, the more rapid the gasification process will be, although more energy may be needed to achieve such a temperature. Accordingly, in some embodiments, the temperature is selected so as to balance between effective gasification and energy consumption considerations.

TABLE 1
Equilibrium constant (Ke) for gasification and partial pressures of CO, H₂
and H₂O at equilibrium

| | Temperature (° C.) | | | | | |
|---|---|---|---|---|---|---|
| | 500 | 700 | 900 | 1000 | 1100 | 1300 |
| Log Ke (Log P_{H2O}/P_{CO}P_{H2}) | 1.67 | −0.13 | −1.43 | −1.91 | −2.34 | −3.02 |
| P_{CO}, P_{H2} | 0.119 | 0.418 | | | | |
| P_{H2O} | 0.762 | 0.164 | | | | |

In some embodiments, heating for gasification comprises contacting the suspension with a hot gas. The hot gas can be produced by combustion of a material or a mixture of materials. Optionally, the gas comprises steam (product of water formed during combustion). Steam may facilitate gasification by reacting directly with carbon to produce CO and H₂.

In some embodiments, gasification further comprises reaction of carbon-containing material (e.g., fuel, organic matter from the sewage sludge) with oxygen to produce a gas (e.g., CO).

In some embodiments, combustion of the gas obtained from gasification comprises adding an oxygen source. Optionally, air (e.g., compressed air) is used as an oxygen source.

During combustion, CO is oxidized to CO₂ and H₂ is oxidized to H₂O (water vapor).

It is to be appreciated that although the gasification of carbon is an endothermic reaction, the coupling of combustion of the obtained gases with the gasification process results in a net oxidation of carbon to CO₂ (with CO and H₂ merely being intermediates), which is a considerably exothermic reaction:

C+O₂→CO₂(−393.51 kJ/mol)

The method described herein therefore releases considerable amounts of heat via combustion of carbon-containing material, including the organic matter in the sewage sludge. The heat can be utilized, for example, for generating power.

As exemplified below in the Examples section, the present inventors have designed a system for treating sewage sludge in an efficient and convenient manner, e.g., according to a method described herein.

Hence, according to another aspect of embodiments of the invention, there is provided a system for treating sewage sludge.

The system comprises a mixer configured for receiving sewage sludge, for receiving a carbonaceous fuel (e.g., a fuel described herein), and for mixing the fuel with the sewage sludge so as to form a suspension (e.g., a suspension described herein). Optionally, the mixer is configured for further receiving a plasticizer (e.g., a plasticizer described herein).

The system further comprises a gasifier configured for receiving the suspension from the mixer (e.g., being in communication with the mixer), and adapted for producing a gas comprising CO and H₂ from the suspension. Thus, the gasifier is adapted for withstanding the temperatures (e.g., a gasification temperature described herein) and pressures involved in gasification, as well as chemical attack (e.g., by CO).

The system further comprises a heat source configured, along with the gasifier, such that the heat source is capable of heating the gasifier to a desired temperature. The heat source optionally comprises a furnace (also referred to herein as an “antechamber”) which generates heat, for example, by burning a solid liquid and/or gaseous fuel (e.g., coal, gas, gasoline). The furnace may burn the same fuel mixed into the suspension and/or a different fuel.

The system further comprises a combustion module (e.g., comprising an afterburning chamber) configured for receiving oxygen (e.g., as air) and for combusting the gas produced in the gasifier. The combustion module is in communication with the gasifier so as to receive the combustible gas produced in the gasifier and combine the combustible gas with the oxygen. Optionally, the communication between the gasifier and combustion module is regulated (e.g., by a controller) such that gas enters the combustion module at controlled times and/or flow rates. Optionally, the combustion module comprises a burner which mixes the incoming oxygen and incoming combustible gas, so as to form a readily ignitable gas/oxygen mixture.

The system is optionally configured such that the oxygen and combustible gas are mixed in the combustion module. Alternatively, the system is configured such that the oxygen and combustible gas are mixed prior to entering the combustion module, and are then supplied together to the combustion module. In some embodiments, a controller regulates the amount (e.g., flow rate) of oxygen being mixed with the combustible gas.

Optionally, the system further comprises one or more supply modules, such as a sewage sludge supply module, a fuel supply module, and/or a plasticizer supply module.

The supply module(s) is optionally adapted for storing a supply of a substance and/or for controlling a supply (e.g., flow rate) of a substance, for example, to a mixer and/or a grinder described herein.

In some embodiments, the system further comprises a grinder capable of pulverizing a solid fuel into fine particles (e.g., particles described herein).

A grinder may optionally be configured for grinding a solid fuel before the fuel enters the mixer. Alternatively, or additionally, a grinder is configured within the mixer, such that the mixer both grinds the fuel and mixes the fuel with the sewage sludge.

In some embodiments, the grinder provides ground fuel to a fuel supply module. Optionally, the grinder is a component of the fuel supply module.

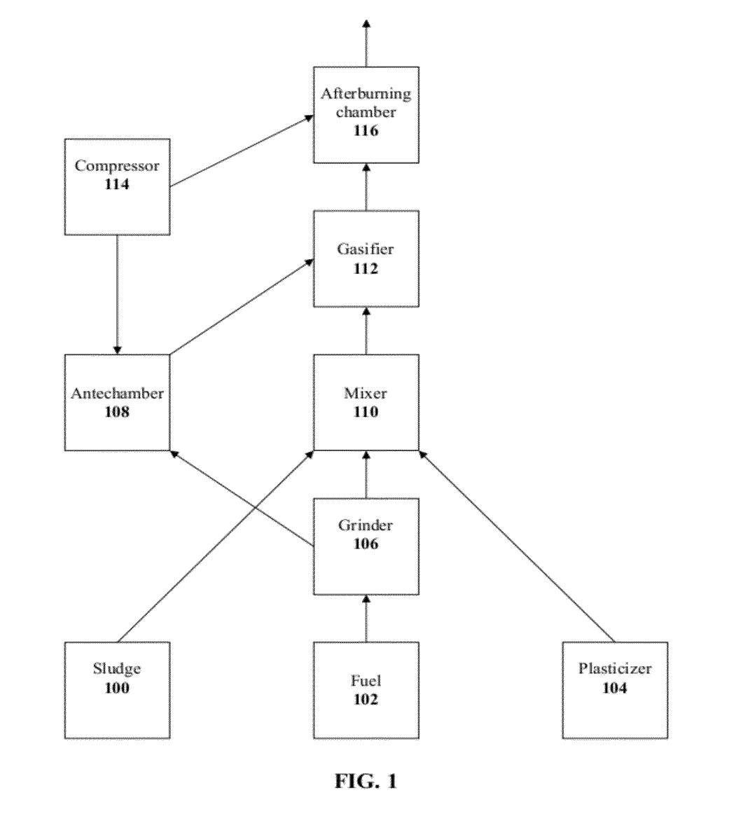

Referring now to the drawings, FIG. 1 illustrates a system according to some embodiments of the invention. A mixer 110 receives fuel 102 and sewage sludge 100, and optionally also a plasticizer 104 (as described herein). An optional grinder 106 (e.g. a mill) is adapted for grinding fuel 102 into small particles (e.g., as described herein). The system is optionally configured such that a portion of fuel 102 is directed (e.g., from grinder 106) to an antechamber 108 which produces heat for heating gasifier 112, and a portion of fuel 102 is directed to mixer 110 for being mixed with sewage sludge 100. Fuel 102 is burned in antechamber 108, and the system is configured such that heat produced in antechamber 108 heats gasifier 112. Optionally, antechamber 108 is in communication with gasifier 112, such that at least a portion (e.g., approximately 10%) of the hot combustion products (e.g., water vapor) exiting antechamber 108 as exhaust are supplied to gasifier 112. Gas produced in gasifier 112 enters afterburning chamber 116 of the combustion module, undergoes combustion, and the combustion products exit afterburning chamber 116 by a suitable outlet. Optionally, a compressor 114 is included, being configured for supplying oxygen (e.g., in the form of compressed air) to antechamber 108 and/or afterburning chamber 116.

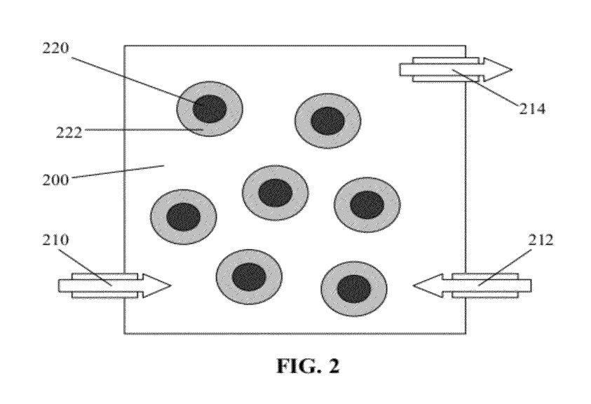

FIG. 2 schematically depicts a mixer and suspension according to some embodiments of various aspects of the invention. Coal and sewage sludge enter mixer 200 via separate inlets 210 and 212, and a suspension is formed comprising coal particles 220 coated by an “envelope” 222 of water which adheres to the surface of the particles (individual coated particles are shown enlarged). The suspension then exits the mixer via outlet 214. The water “envelopes” optionally comprise substantially all of the water in the suspension. Alternatively, the suspension comprises considerable amounts of water in addition to the water in the “envelopes”.

In some embodiments, the thickness of the envelope is determined by the hydrophobicity of the fuel particles. The hydrophobicity of the particles may optionally be modulated by adding a suitable amount of plasticizer added. For example, a water envelope surrounding coal particles may comprise from 0.37 cm³ water per gram coal (in the absence of a plasticizer) to 32 cm³ water per gram coal (in the presence of a plasticizer) [Kulman, Physical and Colloid Chemistry, p. 446, Techizdat, Moscow, 1957]

According to optional embodiments of the method and system described herein, combustion of the gas is utilized to produce power, e.g., mechanical and/or electrical power.

Power is optionally generated by a gas turbine, a steam turbine and/or a heat engine. Optionally, the system comprises a heat exchanger which transfers heat generated by combustion (e.g., from combustion products) to a heat engine.

Thus, the system described herein optionally comprises a power generation module configured for generating power from the combustion of gas in the combustion module.

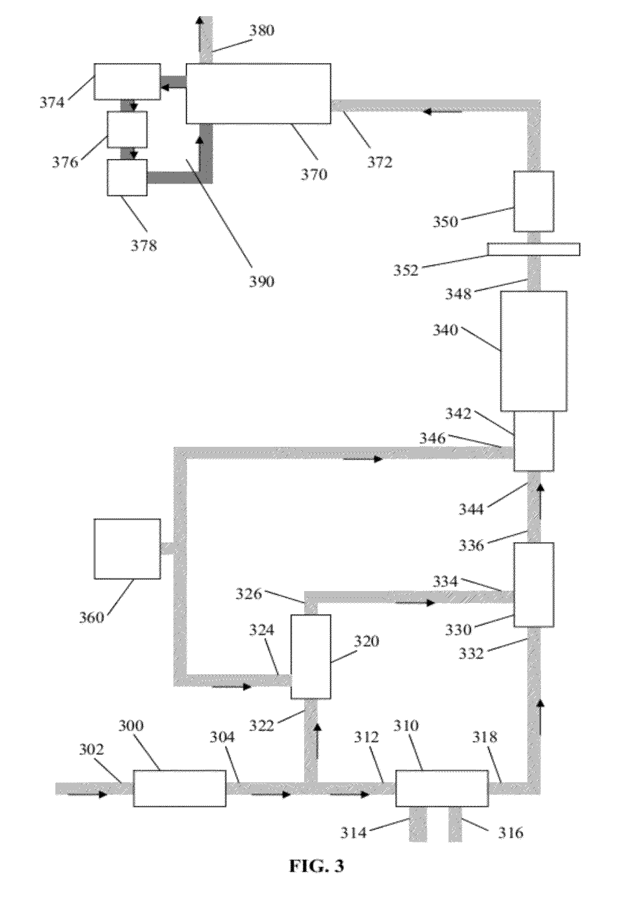

In exemplary embodiments, a combined cycle, comprising a gas turbine and a steam turbine, generates power. FIG. 3 illustrates an exemplary sewage sludge treatment system with combined cycle power generation, according to some embodiments of the invention, and is discussed in detail in the Examples section below (in Example 1).

Optionally, power generation module comprises a gas turbine configured to receive the gaseous combustion products (e.g., CO₂, N₂, steam) exiting the combustion module under pressure.

Alternatively or additionally, the power generation module comprises a heat engine (e.g., comprising a steam turbine) configured to receive heat escaping from the combustion module and/or the heat source described herein. Optionally, the heat engine is configured to utilize heat remaining after the combustion products have passed through the gas turbine, for example, by producing steam for a steam cycle.

According to optional embodiments of the method and system described herein, at least a portion of the power generated as described herein is utilized to power one or more components described herein, such as a compressor (e.g., air compressor), a grinder and/or a mixer.

It is to be appreciated that generation of mechanical and/or electrical power, as described herein greatly improves the energy efficiency of the sewage sludge treatment and reduces the net economic cost thereof, as the solid matter in the sewage sludge is effectively used as a fuel for power generation.

The various components of the system described herein may all optionally be present as distinct modules, connected, for example, hydraulically (e.g., by pipes). Alternatively, at least some of the components described herein are joined together, that is, configured as a unified module. A unified module optionally comprises a plurality of zones, whereby different zones correspond to the different system components described herein

Thus, in some embodiments, the gasifier and the heat source (e.g., furnace) for heating the gasifier are configured as a unified module comprising a first zone in which combustion occurs (the zone corresponding to a furnace described herein for heating a gasifier) and a second zone in which gasification occurs (the zone corresponding to a gasifier described herein). According to exemplary embodiments, the unified module further comprises a third zone in which combustion of the gas from the second zone occurs, the zone corresponding to a combustion module described herein.

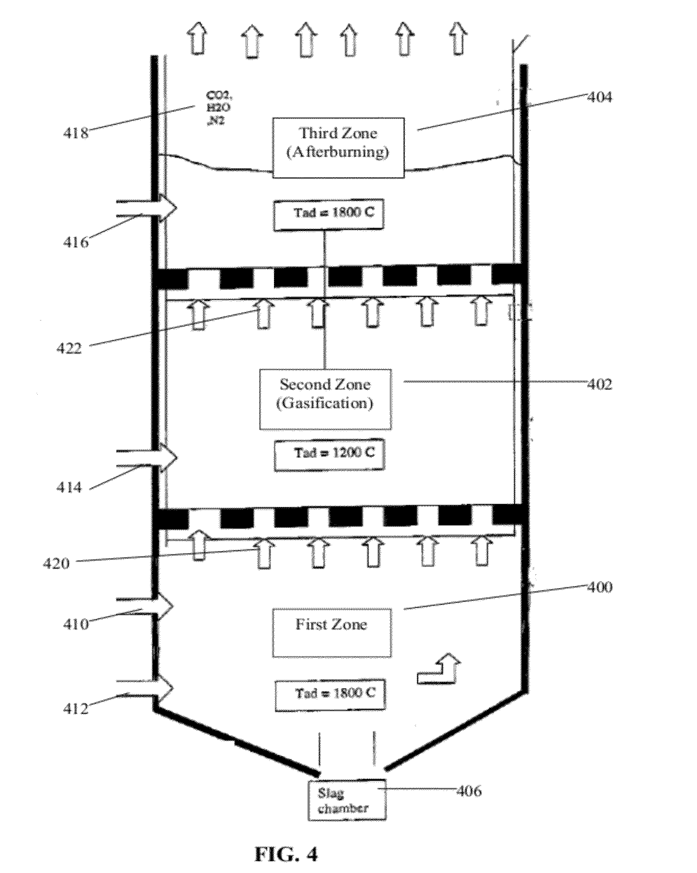

FIG. 4 illustrates an exemplary three-zone unified module according to some embodiments of the invention, and is discussed in detail in the Examples section below (in Example 2).

In some embodiments, the mixer and the gasifier are combined as a unified module.

Optionally, the system is further configured for transferring (e.g., via pumping) a viscous (e.g., up to 1500 MPa·seconds) suspension from one part of the system to another.

According to optional embodiments, the system further comprises an atomizer configured for atomizing the suspension upon entry into the gasifier. Optionally, the atomizer receives a supply of pressurized air from an air compressor (e.g., a compressor described herein).

In some embodiments, the atomizer comprises a rotating part, such as a flat disc (e.g., a disc characterized by a diameter of from 2 to 5 cm), within a tubular component (e.g., a pipe). The rotating part is optionally configured for rotating at a speed of from 1.6 to 5 revolutions per second (e.g., being rotated by an engine). The tubular component is optionally configured for pumping a suspension (e.g., at a flow rate of up to 10 liters per hour) with a viscosity of from 1 to 1500 MPa·seconds.

In some embodiments, the viscosity is in a range of from 1 to 800 MPa·seconds.

In some embodiments, the viscosity is in a range of from 200 to 1500 MPa·seconds.

The atomizer described herein is useful for enhancing dispergation of a viscous suspension and reducing clogging of the atomizer.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non-limiting fashion.

### Example 1

### Sewage Sludge Treatment System with Combined Cycle Power Generation

FIG. 3 shows a scheme of an exemplary system which combines treatment of sewage sludge and power generation. FIG. 3 shows the basic components as shown in FIG. 1, with the addition of more details, including a combined cycle comprising gas turbine 350 and steam cycle 390 for generating power.

The system comprises a grinder 300 (e.g., a colloidal mill) for grinding a solid fuel (e.g., coal) in solid form or as a slurry. Grinder 300 receives fuel through an inlet 302, and ground fuel exits through an outlet 304 to both a mixer 310 and an antechamber 320. Mixer 320 receives fuel through an inlet 312 and sludge through an inlet 314, and optionally also plasticizer through an optional inlet 316. Mixer 310 produces a suspension of ground fuel in sludge, optionally stabilized by the plasticizer, which exits through an outlet 318 to a gasifier 330. An antechamber 320, which operates as a combustion chamber, receives ground fuel through an inlet 322 and air through an inlet 324. Hot combustion products exit antechamber 320 through an outlet 326 to gasifier 330. Gasifier 330 receives suspension from mixer 310 through an inlet 332 and hot combustion products from antechamber 320 through an inlet 334. In gasifier 330, the suspension is converted to a combustible gas. The gas exits gasifier 330 through an outlet 336 to an afterburning chamber 340. Afterburning chamber 340 comprises a burner 342, which receives gas from gasifier 330 through an inlet 344 and air through an inlet 346. Gas from gasifier 330 undergoes combustion in afterburning chamber 340, and the hot combustion products exit through an outlet 348 to a gas turbine 350. An optional filter 352 filters combustion products exiting afterburning chamber 340. A compressor 360 provides air to antechamber 320 and afterburning chamber 340 through inlets 324 and 346, respectively. A steam cycle 390 comprises a heat recovery steam generator 370, a steam turbine 374, a condenser 376 and a pump 378. Heat recovery steam generator 370 receives hot gases through an inlet 372 from gas turbine 350. The cooled gases then exit steam generator 370 through an outlet 380 as flue gases.

Gas turbine 350 and steam turbine 374 each produce mechanical and/or electrical power.

### Example 2

### Unified Module for Gasification and Combustion

FIG. 4 depicts an exemplary furnace comprising three zones, which can perform gasification of sewage sludge and combustion of the gas produced by gasification.

A first zone 400 receives solid, liquid and/or gaseous fuel (e.g., coal, gas, gasoline) and oxygen (e.g., air) via suitable inlets 410 and 412, and the fuel undergoes combustion therein, resulting in a temperature of about 1800° C. Slag remaining from combustion falls into a slag chamber 406, and can be readily disposed of.

A second (gasification) zone 402 receives a fuel/sewage sludge suspension via a suitable inlet 414, as well as heat and hot combustion products 420 from the first zone. The temperature in second zone 402 is about 1200° C., at which temperature the suspension is gasified readily to CO and H₂ gas. Optionally, second zone 402 receives fuel and sewage sludge (and optionally a plasticizer) via separate inlets (not shown), and further comprises a mixer (not shown) to form a suspension from the fuel and sewage sludge (and optional plasticizer).

A third (afterburning) zone 404 receives gas 422 from second zone 402, as well as oxygen (e.g., air) via a suitable inlet 416. The CO and H₂ gases undergo combustion to CO₂ and H₂O, respectively, resulting in a temperature of about 1800° C. Gases 418, comprising CO₂ and H₂O, as well as other gases formed in the furnace (e.g., N₂), exit the furnace from third zone 404.

The three-zone furnace described above is suitable as a component of a sewage sludge treatment system described herein, and comprises an antechamber (corresponding to the first zone), gasifier (corresponding to the second zone) and afterburning chamber (corresponding to the third zone), and optionally a mixer (in the second zone), in a unified module.

Unification of the different zones in a single furnace can advantageously reduce the amount of heat escaping from the system.

The furnace described above is optionally coupled to system for power generation (e.g., a gas turbine and/or a steam turbine), for example, in accordance with the system described in Example 1.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-42. (canceled)

43. A method of treating sewage sludge, the method comprising:
(a) mixing a carbonaceous fuel with the sewage sludge so as to form a suspension;
(b) gasifying said suspension so as to produce a gas comprising CO and H₂, said gasifying being an endothermic process comprising heating said suspension; and
(c) combusting said gas,
thereby treating the sewage sludge.

44. The method of claim 43, wherein said sewage sludge is at least 90% water by weight.

45. The method of claim 43, further comprising generating power from said combusting of said gas.

46. The method of claim 43, wherein said suspension comprises particles of said fuel dispersed in said sewage sludge, said particles being characterized by a diameter of 100 μm or less.

47. The method of claim 46, wherein said particles are characterized by a diameter of 20 μm or less.

48. The method of claim 46, further comprising, prior to said mixing, grinding a solid carbonaceous fuel so as to produce said particles of said fuel.

49. The method of claim 46, further comprising, prior to said mixing, emulsifying a liquid carbonaceous fuel with said sewage sludge so as to produce said particles of said fuel.

50. The method of claim 43, wherein a weight ratio of said fuel to said sewage sludge in said suspension is in a range of from 0.75:1 to 3:1.

51. The method of claim 43, wherein a concentration of water in said suspension is at least 25 weight percents.

52. The method of claim 43, wherein said gasifying comprises heating said suspension to a temperature of at least 1000° C.

53. The method of claim 52, wherein said heating comprises contacting said suspension with hot combustion products which comprise steam.

54. The method of claim 43, further comprising mixing said gas with air prior to said combusting of said gas.

55. The method of claim 43, further comprising mixing a plasticizer with said fuel and said sewage sludge.

56. A system for treating sewage sludge, the system comprising:
(a) a mixer configured for receiving sewage sludge, for receiving a carbonaceous fuel, and for mixing said fuel with said sewage sludge so as to form a suspension;
(b) a gasifier configured for receiving said suspension from said mixer, and adapted for producing a gas comprising CO and H₂ from said suspension by an endothermic process;
(c) a heat source configured for heating said gasifier so as to effect said endothermic process; and
(d) a combustion module configured for receiving oxygen and for combusting said gas produced in said gasifier.

57. The system of claim 56, wherein said sewage sludge is at least 90% water by weight.

58. The system of claim 56, further comprising a power generation module configured for generating power from said combusting of said gas in said combustion module.

59. The system of claim 58, wherein said power generation module comprises a gas turbine and/or a heat engine.

60. The system of claim 56, further comprising a grinder capable of grinding a solid carbonaceous fuel so as to produce particles of said fuel having a diameter of 100 μm or less.

61. The system of claim 60, wherein said particles have a diameter of 20 μm or less.

62. The system of claim 56, being adapted for emulsifying a liquid carbonaceous fuel with said sewage sludge so as to produce particles of said fuel having a diameter of 100 μm or less.

63. The system of claim 56, wherein said heat source comprises a furnace.

64. The system of claim 63, further comprising a fuel supply module configured for providing said carbonaceous fuel to said furnace and to said mixer, said furnace being adapted for burning said fuel.

65. The system of claim 63, wherein said furnace is configured for supplying combustion products to said gasifier, said combustion products comprising steam.

66. The system of claim 63, wherein said furnace and said gasifier are configured as a unified module comprising a first zone in which combustion occurs and a second zone in which gasification occurs.

67. The system of claim 66, wherein said unified module further comprises a third zone in which said combustion of said gas occurs, such that said unified module comprises said furnace, said gasifier and said combustion module.

68. The system of claim 56, wherein said heat source and said gasifier are configured for heating said suspension in said gasifier to a temperature of at least 1000° C.

69. The system of claim 56, being adapted for mixing said fuel with said sewage sludge at a weight ratio in a range of from 0.75:1 to 3:1.

70. The system of claim 56, being adapted for forming a suspension comprising at least 25 weight percents of water.

71. The system of claim 56, further comprising an atomizer for atomizing said suspension upon entry into said gasifier.

72. The system of claim 71, wherein said atomizer comprises a rotating part configured for reducing clogging of said atomizer by particles of said fuel in said suspension.

73. The system of claim 56, being adapted for mixing a plasticizer with said fuel and said sewage sludge.
